(19) United States
(12) Patent Application Publication
(10) Pub. No.: US 2018/0079577 A1
(43) Pub. Date: Mar. 22, 2018

(54) Heat-Resistant Easy-Open Package

(71) Applicant: Bemis Company, Inc., Neenah, WI (US)

(72) Inventors: Ross K. Gruetzmacher, Neenah, WI (US); Sarah E. O'Hara, Jr., Appleton, WI (US)

(21) Appl. No.: 15/554,252

(22) PCT Filed: Mar. 17, 2015
(86) PCT No.: PCT/US15/20982

§ 371 Date: Aug. 29, 2017

(51) Int. Cl. B65D 77/20; B32B 1/02; B32B 27/32; B32B 27/36

(52) U.S. Cl. CPC B65D 77/2036; B32B 2270/00; B32B 1/02; B32B 27/32; B32B 27/36; B32B 2307/306; B32B 2307/31; B32B 2307/412; B32B 2307/546; B32B 2307/738; B32B 2307/702; B32B 2307/704; B32B 2435/02; B32B 2439/70; B65D 77/2044

(57) ABSTRACT

The present invention is directed to manually openable heat-resistant packages for containing a product that include a thermoformed tray having a product receiving area and a sealing flange endowed with sufficient heat resistance to withstand the cooking and/or pasteurization/sterilization conditions required to produce a ready-to-eat packaged meal. The tray comprises a bulk layer, and a heat sealing layer in direct contact with the bulk layer. The inventive packages also include a flexible transparent lidding film covering the thermoformed product receiving area comprising a heat sealing layer. The package includes a hermetic seal comprising a perimeter heat seal which circumvents the thermoformed tray formed by heat sealing a portion of the heat sealing layer of the lidding film to the sealing flange of the tray. Only the heat sealing layer of the tray is readily frangible and renders the heat seal manually peelable.

### BACKGROUND OF THE INVENTION

The present invention relates generally to primary packaging and more particularly, to high temperature resistant packages. Specifically, the present invention refers to high temperature resistant package for food and non-food products which are also readily easy to open.

It is known to provide packaged, precooked or partially cooked food products, such as soups, stews, and rice, pasta or wheat products that can be reheated in a short time, for example in a microwave or conventional oven. It is important that the lidding film be clear and transparent in order for the food product to be visible to the consumer at the point of sale. These products are sometimes referred to as “ready-to-heat” or “one-minute” meals. When such products are produced, the food product is placed in a rigid tray, whereupon a flexible plastic lidding film is heat-sealed to the top or flange of the tray. The package with the food product contained therein is then inserted into a microwave tunnel for cooking and/or pasteurization/sterilization of the food product to the ready-to-eat state, and during this cooking and/or pasteurization/sterilization process vapor from the food product is produced creating pressure in excess of three to four times atmospheric pressure. The temperature within the package may reach 100° C. (212° F.) during the pasteurization/sterilization and may reach even higher temperatures during a cooking operation. As a consequence of these conditions, high demands are placed on the packaging materials. Typical ready-to-heat containers are made from polyethylene terephthalate (PET), crystalline polyethylene terephthalate (CPET) and/or amorphous polyethylene terephthalate (APET) which are dimensionally stable under these temperatures and pressures. For example, trays are generally constructed from crystalline polyethylene terephthalate (CPET), aluminum or cardboard coated with a heat sealable amorphous polyethylene terephthalate (APET) and lidding films constructed with a heat sealable layer of polyethylene terephthalate (PET) or amorphous polyethylene terephthalate (APET). It is important that there is sufficient adhesion between these materials under cooking and/or pasteurization/sterilization conditions in order to maintain a hermetic heat seal which protects the product from exterior abuse and environmental contamination. However, because the bonds between these materials tend to be very strong, the package is difficult to open without the use of knife or other cutting implement.

Mixtures of polyolefins such as polyethylene, anhydride-modified polyethylene, ethylene vinyl acetate copolymers with polybutene-1 or some pressure sensitive adhesives are sometimes useful in producing peelable or peelable/resealable lidding films that are used to cover trays. However, films and laminates comprising such materials generally do not possess sufficient heat resistance to withstand the cooking and/or pasteurization/sterilization conditions. These materials frequently delaminate because they include thermoplastic materials with relatively low melting temperatures. Moreover, peelable lidding films and laminates containing mixtures with high melting temperature thermoplastic materials such as polyethylene terephthalate (PET) and polyolefin are typically very hazy (haze values greater than 10) or cloudy and do not possess the desirable transparency needed for ready-to-eat packaging applications.

Accordingly, there is still a need in the art for an easy-open package having a transparent lidding film and tray both of which endowed with sufficient heat resistance to withstand the cooking and/or pasteurization/sterilization conditions required to produce a ready-to-eat packaged meal.

### SUMMARY OF THE INVENTION

The present invention is directed to manually openable heat-resistant packages for containing a product that include a thermoformed tray having a product receiving area and a sealing flange. The tray comprises a bulk layer, and a heat sealing layer in direct contact with the bulk layer. The inventive packages also include a flexible transparent lidding film covering the thermoformed product receiving area comprising a heat sealing layer. In a preferred embodiment, the heat sealing layer of the lidding film comprises a substantially amorphous aromatic polyester copolymer. In another preferred embodiment, the lidding film has sufficient optical transparency to permit viewing of a packaged article. Accordingly, in another preferred embodiment, the lidding film has a haze value of 10% or less.

One important aspect of the present invention is that the package includes a hermetic seal comprising a perimeter heat seal which circumvents the thermoformed tray formed by heat sealing a portion of the heat sealing layer of the lidding film to the sealing flange of the tray. This hermetic seal must have a seal strength low enough to permit manual opening, yet be sufficiently high enough to prevent failure of the seal during the cooking and/or pasteurization/sterilization process and further during normal handling and transport of the packaged article. Accordingly, in a preferred embodiment, the hermetic seal remains sealed while subjected to a temperature of 100° C. for between 1-10 minutes and under an internal pressure of between 3-4 psi.

Another important aspect of the present invention is that only the heat sealing layer of the tray is readily frangible and renders the heat seal manually peelable.

A “manually peelable seal” and like terminology is used herein to refer to a seal, and especially heat seals, which are engineered to be readily peelable without uncontrolled or random tearing or rupturing the packaging materials which may result in premature destruction of the package and/or inadvertent contamination or spillage of the contents of the package. A manually peelable seal is one that can be manually peeled and/or fractured apart to open the package at the seal without resort to a knife or other implement to open the package. In the present invention, the peelable seal must have a seal strength sufficient to prevent failure of the seal during the cooking and/or pasteurization/sterilization process and further normal handling and transport of the packaged article. The seal strength must also be low enough to permit manual opening of the seal. The manually peelable seals of the present invention may have seal strengths of between 500 g/in and 3,000 g/in at 93° C. (200° F.), or between 1000 g/in and 3,000 g/in at 93° C. (200° F.), or between 2000 g/in and 3,000 g/in at 93° C. (200° F.). In contrast, non-peelable seals have seal strengths greater than 3,000 g/in at 93° C. (200° F.).

To this end, the heat sealing layer of the tray comprises a blend of a substantially amorphous aromatic polyester copolymer and a polyester-immiscible contaminant. The selection of a substantially amorphous aromatic polyester copolymer for use in the present invention may be governed by various considerations. For example, although not intending to be bound by theory, it is believed that the use of a slower crystallizing aromatic copolymers are preferred because they produce a material with fewer crystalline domains after the tray has under gone the thermoforming process. Fewer crystalline domains consequently decrease the sealing temperature of the sealing layer of the tray that would otherwise be much closer to the melting point of the crystalline domains. Melting points of some aromatic polyester are typically above 250° C. (482° F.). A lower sealing temperature is highly desirable because it affords heat sealing to similar materials such as polyethylene terephthalate or amorphous polyethylene terephthalate at standard package manufacturing conditions. In one preferred embodiment, the heat sealing layer comprises between 40% and 85% by weight of a substantially amorphous aromatic polyester copolymer relative to the total weight of the heat sealing layer. The substantially amorphous aromatic polyester copolymer may include, but is not limited to polyethylene terephthalate, polytrimethylene terephthalate, polybutylene terephthalate, polyhexamethylene terephthalate; polyethylene-2,6-naphthalate, polytrimethylene-2,6-naphthalate, polybutylene-2,6-naphthalate, polyhexamethylene-2,6-natphthalate, polyethylene isophthalate, polytrimethylene isophthalate, polybutylene isophthalate, polyhexamethylene isophthalate, poly-1,4-cyclohexane-dimethanol terephthalate, and polybutylene adipate terephthalate. In one preferred embodiment, the heat sealing layer of the tray comprises a substantially amorphous polyethylene terephthalate or a substantially amorphous polyethylene terephthalate/isophthalate copolymer.

In one preferred embodiment, the substantially amorphous aromatic polyester copolymer of the heat sealing layer of the tray comprises a terephthalatic acid repeating component and a diethylene glycol diol repeating component. In another preferred embodiment, the substantially amorphous aromatic polyester copolymer comprises only a terephthalatic acid repeating component and greater than 2 mole % of the diethylene glycol diol repeating component. In still another preferred embodiment, the substantially amorphous aromatic polyester copolymer comprises only a terephthalatic acid repeating component and at least 37 mole % relative to the total copolymer composition of the diethylene glycol repeating component. An example of a commercially available substantially amorphous aromatic polyester copolymer having only a terephthalatic acid repeating component and at least 37 mole % of a diethylene glycol diol repeating component is EASTOBOND Copolyesters 19411 and 19412 supplied by Eastman Chemical Company, Kingsport, Tenn., USA. It is believed that EASTOBOND Copolyesters 19411 and 19412 have no cyclohexanedimethanol. Alternatively, in another preferred embodiment, the aromatic polyester copolymer may include both a terephthalatic acid repeating component and an isophthalatic acid repeating component. The terephthalatic acid repeating component/isophthalatic acid repeating component combination may also include a diethylene glycol repeating component. An example of a commercially available substantially amorphous aromatic polyester copolymer having both a terephthalatic acid repeating component, an isophthalatic acid repeating component and a diethylene glycol repeating component is Type 7391 resin supplied by Indorama Auriga Polymers Inc. Charlotte, N.C., USA.

The polyester-immiscible contaminant may be any material which when mixed with the aromatic polyester copolymer renders the heat sealing layer of the tray peelable after heat sealing the same to a polyethylene terephthalate or amorphous polyethylene terephthalate substrate (or lidding film). Generally, the polyester-immiscible contaminant may be any polyolefin resin which when mixed with aromatic polyester copolymer produces visibly observable domains of aromatic polyester copolymer and polyester-immiscible contaminant under magnification. Suitable polyolefins for use as a polyester-immiscible contaminant include, but are not limited to, polyethylene, polypropylene, polybutene (or polybutene-1) and blends thereof. The term “polyethylene” as used herein includes homopolymers of ethylene and copolymers of at least about 85% by weight of ethylene with up to about 15% by weight of one or more C₃ to C₁₀ alpha-olefins, such as 1-butene, 1-hexene, etc. Preferably, the copolymers include from about 0.1 to about 3 weight percent of the alpha-olefin comonomer. In one preferred embodiment, the polyester-immiscible contaminant is a high density polyethylene. High density polyethylene is typically recognized (and is defined for the purposes of the present invention) as a substantially linear, semi-crystalline, polymer of ethylene (preferably a homopolymer but also on occasion containing very minor amounts of other well-known comonomers), possessing a density of 0.94 g/mL or higher.

The substantially amorphous aromatic polyester copolymer and a polyester-immiscible contaminant may be blended by any method known in the art. For example, dry blenders such as drum blenders or ribbon mixers including high intensity Henschel or Welex mixers may be used. Melt blenders such as single extruders and multi-screw extruders may also be used to blend these resins. Twin-screw extruders are one preferred blending device since excellent distributive and dispersive mixing are provided using this type of extruder. Additionally, counter-rotating and co-rotating twin screw extruders may also be used to blend the polymers. One example of a suitable blending device is a ZSK-30 twin screw extruder manufactured by Werner & Pfleiderer (Tamm, Germany). It will be appreciated by those skilled in the art that variations of processing parameters such as, but limited to, feed rate of resins or blends of resins, screw speed (rpm), screw length, screw diameter, barrel zone temperatures can each affect the material and performance properties of the resulting blends.

Those skilled in the art will recognize that the relative amounts of polyester-immiscible contaminant to substantially amorphous aromatic polyester copolymer of the heat sealing layer of the tray may vary depending upon the method of blending these materials together. For example, when using a some dry blending methods or low intensity mixing techniques, the ratio of polyester-immiscible contaminant to substantially amorphous aromatic polyester copolymer will be relatively low with the percentage of polyester-immiscible contaminant ranging from between about 15% and 60% based on the total weight of the heat sealing layer. In contrast, when using a some melt blending methods or high intensity mixing techniques, the ratio of polyester-immiscible contaminant to substantially amorphous aromatic polyester copolymer will be relatively high with the percentage of polyester-immiscible contaminant ranging from between about 30% and 80% based on the total weight of the heat sealing layer. In a preferred embodiment, the heat sealing layer of the tray comprises between 30% and 80% by weight of a polyester-immiscible contaminant relative to the total weight of the heat sealing layer.

Preferred materials for use as a lid and/or tray may also provide a beneficial combination of one or more or all of the below noted properties including high puncture resistance (e.g., as measured by the ram and/or hot water puncture tests), low shrinkage values, low haze, high gloss, high seal strengths and printability. Since the inventive packages may advantageously be used to hold oxygen or moisture sensitive articles, it may be preferred to include an oxygen and/or moisture barrier layer in the lidding film and/or the tray. The terms “barrier” or “barrier layer” as used herein means a layer of a multilayer film which acts as a physical barrier to moisture and/or oxygen molecules.

Oxygen barrier materials which may include, but are not limited to, ethylene vinyl alcohol copolymers (EVOH), polyacrylonitriles, polyamides (nylons), vinylidene chloride copolymers (PVDC) crystalline polyethylene terephthalate polymer (CPET). For some applications, the oxygen barrier material may also include metal foils, such as aluminum foil and barrier coatings deposited onto a polymer layer such as silica, alumina and the like. The phrase “barrier coating” refers to a coating that may be applied to one or both surfaces of a film by any known method such as sputtering, vacuum deposition or electroplating (all of which involve some act or method of “depositing” a continuous inorganic material, metal, metal oxide, metal alloy, silicon or silicon oxide layer onto the surface of a polymer substrate). The metal used can vary, though aluminum, zinc, gold, silver or appropriate alloys of such are preferred, with aluminum or aluminum-containing alloys being particularly preferred.

In accordance with the present invention, the oxygen barrier material in both the lidding film and tray provides the package with an oxygen transmission rate of less than about 1.0 cm³/100 in²/24 h at 73° F., 0% RH and 1 atm (or about 15.5 cm³/m²/24 h at 23° C., 0% RH and 1 atm), preferably, less than about 0.5 cm³/100 in²/24 h at 73° F., 0% RH and 1 atm (or about 7.75 cm³/m²/24 h at 23° C., 0% RH and 1 atm), and most preferably, about 0.2 cm³/100 in²/24 h at 73° F., 0% RH and 1 atm (or about 3.1 cm³/m²/24 h at 23° C., 0% RH and 1 atm).

### BRIEF DESCRIPTION OF THE DRAWINGS

Further features and advantages of the present invention will become apparent from the following detailed description, taken in combination with the appended drawings, in which:

FIG. 1 illustrates a schematic view of one embodiment of a package in the closed state according to the present invention,

FIG. 2 illustrates a schematic view of one embodiment of a package in a partially opened state according to the present invention.

FIG. 3 illustrates a cross-sectional view of one embodiment of a tray according to the present invention.

FIG. 4 illustrates a cross-sectional view of one embodiment of a lidding film according to the present invention.

FIG. 5 illustrates an enlarged cross-sectional view of one embodiment of the lidding film peeling away from the tray taken along line A-A of FIG. 2 according to the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

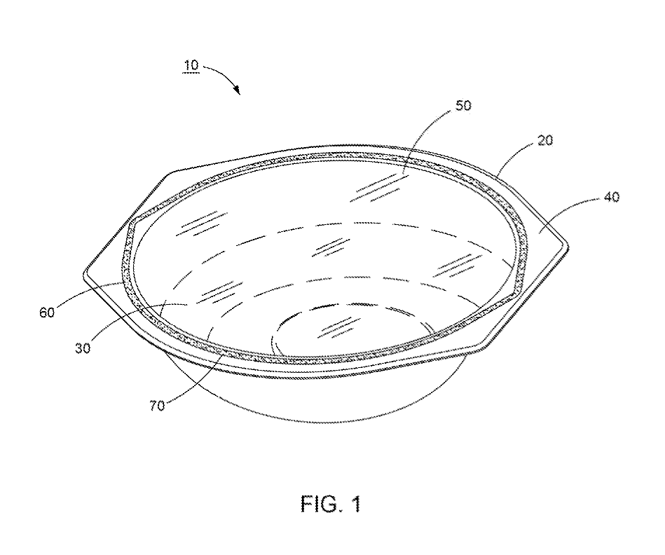

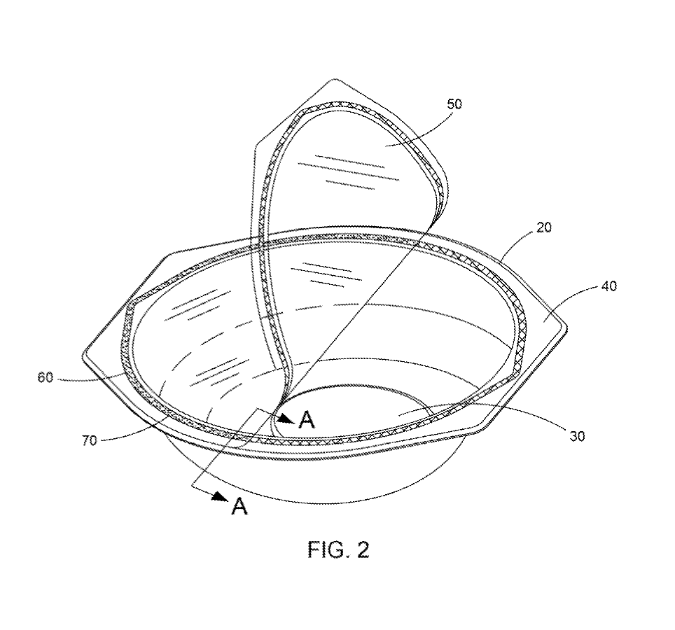

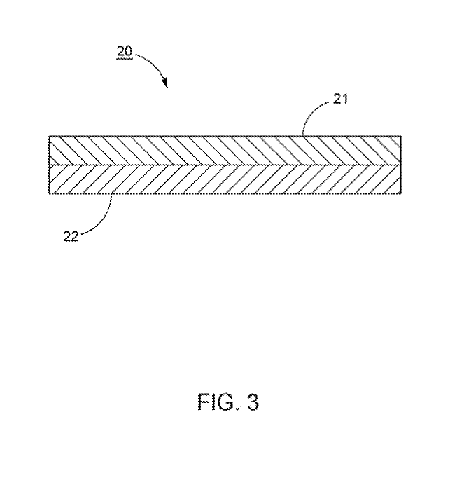

Referring now more particularly to FIGS. 1 and 2 of the drawings, a preferred embodiment of package 10 embodying the present invention is shown in its closed and partially opened state, respectively. In one preferred embodiment, package 10 comprises a rigid or semi-rigid thermoformed tray 20 having a product receiving area 30 and a sealing flange 40 circumscribing the product receiving area 30. It will be noted that tray 20 may be of any shape desired, such as, for example, rectangular, square, circular or polygon depending on both functional and aesthetic requirements. It will be also appreciated that tray 20 may have any depth as desired depending upon type and amount of food product container therein. It will be further appreciated that tray 20 may be configured to include two or more recessed areas depending again on both functional and aesthetic requirements. Tray 20 also includes a bulk layer 22 (shown in FIG. 3) and a heat sealing layer 21 (shown in FIG. 3) which is in direct contact with bulk layer 22. A more detailed description of sealing layer 21 and bulk layer 22 is provided herein below,

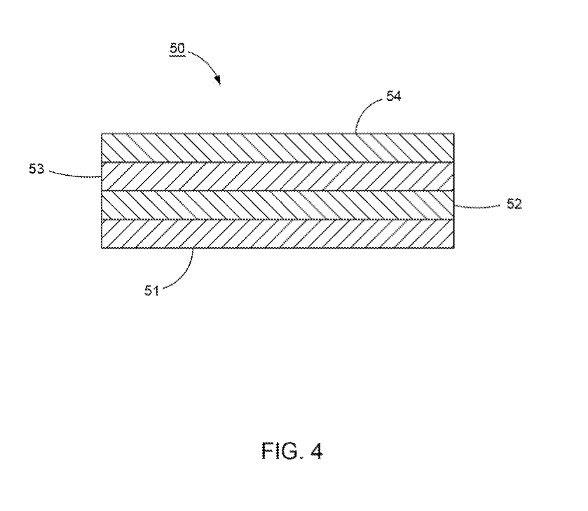

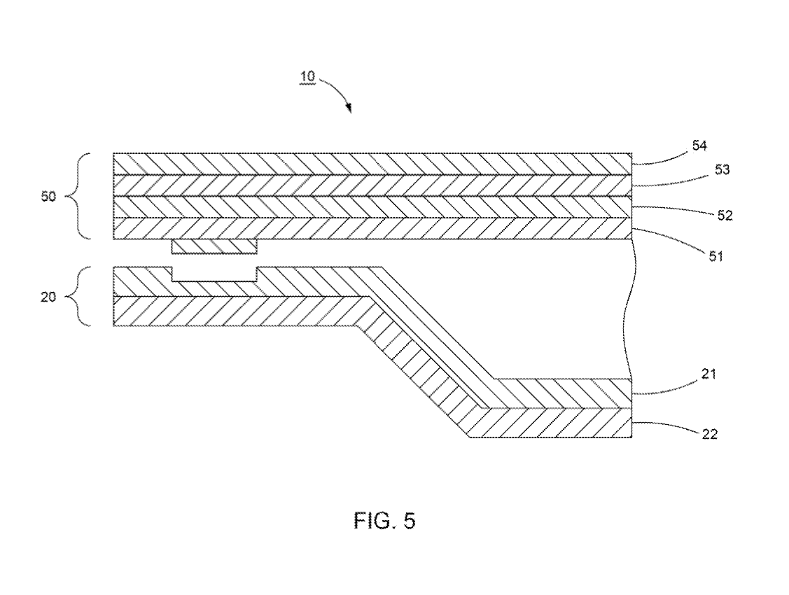

Further included with package 10 is a flexible lidding film 50 which covers the product receiving area 30. Package 10 also includes a hermetic seal 60 comprising a perimeter heat seal 70 circumventing the thermoformed tray formed by heat sealing a portion of the heat sealing layer 51 (shown in FIG. 4) of lidding film 50 to sealing flange 40 of the tray. As used herein, the term “heat seal” refers to welding or melting of two polymeric surfaces together by the application of heat and pressure. It will be appreciated by those skilled in the art that heat seals are hermetic seals meaning that they prevent the ingress of air and/or moisture through the seal. In accordance with an important aspect of the present invention, the removal of lidding film 50 as depicted in FIG. 4 from the tray 20 as depicted in FIG. 3 is achieved by peelably tearing lidding film 50 away from tray 20 whereby the heat sealing layer 21 of tray 20 ruptures cohesively within this layer as illustrated in FIG. 5. It should be appreciated that only the heat sealing layer 21 of the tray is readily frangible and renders heat seal 70 manually peelable without the addition of score-lines, cuts or perforations to lidding film 50.

An advantageous optional feature of the present invention is that it may include an integrally formed tamper-evident feature. In one preferred embodiment, the tamper-evident feature comprises a visible whitened area of the sealing flange of the tray produced when the hermetic seal has been breached which occurs when the lidding film is peeled from the tray. In another preferred embodiment, the tamper-evident feature comprises a visible whitened area of the lidding film produced when the hermetic seal has been breached which occurs when the lidding film is peeled from the tray. In still another embodiment, the tamper-evident feature comprises both a visible whitened area of the sealing flange of the tray and a visible whitened area of the lidding film produced when the hermetic seal has been breached which occurs when the lidding film is peeled from the tray.

In a preferred embodiment of the package of the present invention, lidding film may be a mono-layer film comprising heat sealing layer formed from a substantially amorphous aromatic polyester. Specific examples of substantially amorphous aromatic polyester copolymers may include, but are not limited to: polyethylene terephthalate, polytrimethylene terephthalate, polybutylene terephthalate, polyhexamethylene terephthalate; polyethylene-2,6-naphthalate, polytrimethylene-2,6-naphthalate, polybutylene-2,6-naphthalate, polyhexamethylene-2,6-natphthalate, polyethylene isophthalate, polytrimethylene isophthalate, polybutylene isophthalate, polyhexamethylene isophthalate, poly-1,4-cyclohexane-dimethanol terephthalate, and polybutylene adipate terephthalate. Among these, amorphous polyethylene terephthalate is preferably used. In another preferred, lidding film may comprises a multilayer film which includes heat sealing layer formed from an aromatic polyester, especially an amorphous polyethylene terephthalate copolymer and bulk layers, abuse layers, tie layers and/or barrier layers. It should be understood that lidding film may include any number of layers with the condition that it includes at least a heat sealing layer formed from an aromatic polyester. For example, as depicted in FIG. 4, lidding film 50 comprises four distinct layers including a heat sealing layer 51 comprising 1.75 mil thick amorphous polyethylene terephthalate, in direct contact with a bulk layer 52 comprising a 48 gauge thick biaxially oriented polyethylene terephthalate film (OPET), in direct contact with a tie (adhesive) layer 53 comprising a two-part polyurethane adhesive, in direct contact with an abuse layer 54 comprising a 60 gauge thick biaxially oriented nylon film (BOPA). In one preferred embodiment, lidding film 50 was produced by coating bulk layer 52 with an amorphous polyethylene terephthalate layer 51 using conventional cast extrusion methods generally known to those skilled in the art. This two-ply substrate was then adhesively laminated to abuse layer 54 using conventional adhesive lamination methods and equipment also generally known to those skilled in the art. This four-layer film had a haze value of between 5-6%.

Referring back now to FIG. 3, a preferred embodiment of the tray 20 is illustrated comprising a heat sealing layer 21 and a bulk layer 22. Bulk layer 22 may include any material such as, but limited to plastics, aluminum or coated cardboard. If bulk layer 22 is formed from such materials as aluminum or coated cardboard, tray 20 may include additional layer such as a tie layer (not shown) or an adhesive layer (not shown) between bulk layer 22 and heat sealing layer 21. In one preferred embodiment, bulk layer 22 comprises a polyethylene terephthalate. In another preferred embodiment, bulk layer 22 comprises a crystalline polyethylene terephthalate. Various specific examples of heat sealing layer 21 are described herein below.

### WORKING EXAMPLES

### Trays

In the following Examples 1-8, there is described various preferred embodiments of a tray 20 having a two-layer structure as illustrated in FIG. 3. In all these Examples 1-7, a blend was produced by dry mixing the substantially amorphous aromatic polyester copolymer (dried at 180° F. for 12 hours) with the polyester-immiscible contaminant. The blend forming layer 21 was then coextruded with bulk layer 22 of crystalline polyethylene terephthalate using a single screw extruder to form a two-ply film having a sealing layer 21 thickness of approximately 25.4 micron (1 mil) and a bulk layer 22 thickness of approximately 737 micron (29 mil). A tray was thermoformed using conventional methods and equipment well known in the art.

### Example 1

Example 1 is one preferred embodiment of the heat sealing layer 21 of tray 20 of the present invention having a structure and layer compositions as described below. Reported below is the layer composition relative to the total weight of the layer.
Layer 21: 100 wt.-% of a blend of 6.8 kg (15 lb) of an amorphous polyethylene terephthalate copolymer (APET)-EASTOBOND Copolyester 19412 (Eastman Chemical Company, Inc., Kingsport, Tenn., USA)+6.8 kg (15 lb) of a high density polyethylene (HDPE)-Alathon® L5885 (having a density of 0.958 g/cc and a melt index of 0.85 g/10 min) (Lyondell Chemical Company, Houston, Tex., USA).
Layer 22: 100 wt.-% of a crystalline polyethylene terephthalate film (CPET)-Preformance™ PET 1708 (StarPET, Inc., Asheboro, N.C., USA).

### Example 2

Example 2 is another preferred embodiment of the heat sealing layer 21 of tray 20 of the present invention having a structure and layer compositions as described below. In this embodiment, layers 21 and 22 were prepared in a manner similar to that described above for Example 1 except for the composition of sealing layer 21. Reported below is the layer composition relative to the total weight of the layer.
Layer 21: 100 wt.-% of a blend of 8.16 kg (18 lb) of an amorphous polyethylene terephthalate copolymer (APET)-EASTOBOND Copolyester 19412 (Eastman Chemical Company, Inc. Kingsport, Tenn., USA)+5.44 kg (12 lb) of a high density polyethylene (HDPE)-Alathon® L5885 (having a density of 0.958 g/cc and a melt index of 0.85 g/10 min) (Lyondell Chemical Company, Houston, Tex., USA).
Layer 22: 100 wt.-% of a crystalline polyethylene terephthalate film (CPET)-Preformance™ PET 1708 (StarPET, Inc., Asheboro, N.C., USA).

### Example 3

Example 3 is another preferred embodiment of the heat sealing layer 21 of tray 20 of the present invention having a structure and layer compositions as described below. In this embodiment, layers 21 and 22 were prepared in a manner similar to that described above for Example 1 except for the composition of sealing layer 21. Reported below is the layer composition relative to the total weight of the layer.
Layer 21: 100 wt.-% of a blend of 8.85 kg (19.5 lb) of an amorphous polyethylene terephthalate copolymer (APET)-EASTOBOND Copolyester 19412 (Eastman Chemical Company, Inc., Kingsport, Tenn., USA)+4.76 kg (10.5 lb) of a high density polyethylene (HDPE)-Alathon® L5885 (having a density of 0.958 g/cc and a melt index of 0.85 g/10 min) (Lyondell Chemical Company, Houston, Tex., USA).
Layer 22: 100 wt.-% of a crystalline polyethylene terephthalate film (CPET)-Preformance™ PET 1708 (StarPET, Inc., Asheboro, N.C., USA).

### Example 4a

Example 4 is another preferred embodiment of the heat sealing layer 21 of tray 20 of the present invention having a structure and layer compositions as described below. In this embodiment, layers 21 and 22 were prepared in a manner similar to that described above for Example 1 except for the composition of sealing layer 21. Reported below is the layer composition relative to the total weight of the layer.
Layer 21: 100 wt.-% of a blend of 9.53 kg (21 lb) of an amorphous polyethylene terephthalate copolymer (APET)-EASTOBOND Copolyester 19412 (Eastman Chemical Company, Inc., Kingsport, Tenn., USA)+4.1 kg (9 lb) of a high density polyethylene (HDPE)-Alathon® L5885 (having a density of 0.958 g/cc and a melt index of 0.85 g/10 min) (Lyondell Chemical Company, Houston, Tex., USA).
Layer 22: 100 wt.-% of a crystalline polyethylene terephthalate film (CPET)-Preformance™ PET 1708 (StarPET, Inc., Asheboro, N.C., USA).

### Example 4b

Example 4b is another preferred embodiment of the heat sealing layer 21 of tray 20 of the present invention having a structure and layer compositions as described below. In this embodiment, layers 21 and 22 were prepared in a manner similar to that described above for Example 1 except for the composition of sealing layer 21. Reported below is the layer composition relative to the total weight of the layer.
Layer 21: 100 wt.-% of a blend of 9.53 kg (21 lb) of an amorphous polyethylene terephthalate/isophthalate copolymer (APET)-Type 7391 (Indorama Ventures Auriga Polymers, Inc., Charlotte, N.C., USA)+4.1 kg (9 lb) of a high density polyethylene (HDPE)-Alathon® L5885 (having a density of 0.958 g/cc and a melt index of 0.85 g/10 min) (Lyondell Chemical Company, Houston, Tex., USA).
Layer 22: 100 wt.-% of a crystalline polyethylene terephthalate film (CPET)-Preformance™ PET 1708 (StarPET, Inc., Asheboro, N.C., USA).

### Example 5

Example 5 is another preferred embodiment of the heat sealing layer 21 of tray 20 of the present invention having a structure and layer compositions as described below. In this embodiment, layers 21 and 22 were prepared in a manner similar to that described above for Example 1 except for the composition of sealing layer 21. Reported below is the layer composition relative to the total weight of the layer.
Layer 21: 100 wt.-% of a blend of 10.21 kg (22.5 lb) of an amorphous polyethylene terephthalate copolymer (APET)-EASTOBOND Copolyester 19412 (Eastman Chemical Company, Inc., Kingsport, Tenn., USA)+3.4 kg (7.5 lb) of a high density polyethylene (HDPE)-Alathon® L5885 (having a density of 0.958 g/cc and a melt index of 0.85 g/10 min) (Lyondell Chemical Company, Houston, Tex., USA).
Layer 22: 100 wt.-% of a crystalline polyethylene terephthalate film (CPET)-Preformance™ PET 1708 (StarPET, Inc., Asheboro, N.C., USA).

### Example 6

Example 6 is another preferred embodiment of the heat sealing layer 21 of tray 20 of the present invention having a structure and layer compositions as described below. In this embodiment, layers 21 and 22 were prepared in a manner similar to that described above for Example 1 except for the composition of sealing layer 21. Reported below is the layer composition relative to the total weight of the layer.
Layer 21: 100 wt.-% of a blend of 10.89 kg (24 lb) of an amorphous polyethylene terephthalate copolymer (APET)-EASTOBOND Copolyester 19412 (Eastman Chemical Company, Inc., Kingsport, Tenn., USA)+2.72 kg (6 lb) of a high density polyethylene (HDPE)-Alathon® L5885 (having a density of 0.958 g/cc and a melt index of 0.85 g/10 min) (Lyondell Chemical Company, Houston, Tex., USA).
Layer 22: 100 wt.-% of a crystalline polyethylene terephthalate film (CPET)-Preformance™ PET 1708 (StarPET, Inc., Asheboro, N.C., USA).

### Example 7

Example 7 is another preferred embodiment of the heat sealing layer 21 of tray 20 of the present invention having a structure and layer compositions as described below. In this embodiment, layers 21 and 22 were prepared in a manner similar to that described above far Example 1 except for the composition of sealing layer 21. Reported below is the layer composition relative to the total weight of the layer.
Layer 21: 100 wt.-% of a blend of 11.57 kg (25.5 lb) of an amorphous polyethylene terephthalate copolymer (APET)-EASTOBOND Copolyester 19412 (Eastman Chemical Company, Inc., Kingsport, Tenn., USA)+2.0 kg (4.5 lb) of a high density polyethylene (HDPE)-Alathon® L5885 (having a density of 0.958 g/cc and a melt index of 0.85 g/10 min) (Lyondell Chemical Company, Houston, Tex., USA).
Layer 22: 100 wt.-% of a crystalline polyethylene terephthalate film (CPET)-Preformance™ PET 1708 (StarPET, Inc., Asheboro, N.C., USA).

### Comparative Example 1

Comparative Example 1 is an embodiment of the heat sealing layer 21 of tray 20 having a structure and layer compositions as described below and as illustrated in FIG. 3. Reported below is the layer composition relative to the total weight of the layer.
Layer 21: 100 wt.-% of an amorphous polyethylene terephthalate (APET)-Laser+® C 9921 (F65A) (DAK Americas LLC, Chadds Ford, Pa., USA).
Layer 22: 100 wt.-% of a crystalline polyethylene terephthalate film (CPET)-Preformance™ PET 1708 (StarPET, Inc., Asheboro, N.C., USA).

### Comparative Example 2

Comparative Example 1 is an embodiment of the heat sealing layer 21 of tray 20 having a structure and layer compositions as described below and as illustrated in FIG. 3. Reported below is the layer composition relative to the total weight of the layer.
Layer 21: 100 wt.-% of a blend of 8.85 kg (19.5 lb) of an amorphous polyethylene terephthalate (APET)-Laser+® C 9921 (F65A) (DAK Americas LLC, Chadds Ford, Pa., USA)+4.76 kg (10.5 lb) of a high density polyethylene (HDPE)-Alathon® L5885 (having a density of 0.958 g/cc and a melt index of 0.85 g/10 min) (Lyondell Chemical Company, Houston, Tex., USA),
Layer 22: 100 wt.-% of a crystalline polyethylene terephthalate film (CPET)-Preformance™ PET 1708 (StarPET, Inc., Asheboro, N.C., USA).

In the following Example 8, there is described another preferred embodiment of a tray 20 having a two-layer structure as illustrated in FIG. 3. In Example 8, a blend was produced by first dry blending the substantially amorphous aromatic polyester copolymer (dried at 180° F. for 12 hours) with the polyester-immiscible contaminant, then melt blending the dry mixture and pelletized using a Baker Perkins Twin Screw Extruder Model MP2050 (Baker Perkins Limited, Peterborough, U.K.) with a 50 mm screw diameter approximate 25:1 L/D ratio, and a co-rotating screw design. The blend forming layer 21 was then coextruded with bulk layer 22 of crystalline polyethylene terephthalate using a single screw extruded to form a two-ply film having a sealing layer 21 thickness of approximately 25.4 micron (1 mil) and a bulk layer 22 thickness of approximately 737 micron (29 mil).

### Example 8

Example 8 is another preferred embodiment of the heat sealing layer 21 of tray 20 of the present invention having a structure and layer compositions as described below and. Reported below is the layer composition relative to the total weight of the layer.
Layer 21: 100 wt.-% of a blend of 4.54 kg (10 lb) of an amorphous polyethylene terephthalate copolymer (APET)-Eastman Eastobond™ Copolyester 19212 (Eastman Chemical Company, Inc., Kingsport, Tenn., USA)+6.8 kg (15 lb) of a high density polyethylene (HDPE)-Alathon® L5885 (having a density of 0.958 g/cc and a melt index of 0.85 g/10 min) (Lyondell Chemical Company, Houston, Tex., USA).
Layer 22: 100 wt.-% of a crystalline polyethylene terephthalate film (CPET)-Preformance™ PET 1708 (StarPET, Inc., Asheboro, N.C., USA).

### Seal Strengths

The seal strengths for the different heat sealing layers of Examples 1-8 and Comparative Examples 1-2 were determined by cutting a one-inch wide strip from the formed trays. Each strip was heat sealed to a one-inch wide strip of lidding film 50 as described above (see FIG. 4) using a Sencorp model 12ASL/1 tabletop heat sealer at 350° F. and 40 psi with a dwell time of 3 seconds. The laminated specimens were allowed to cool to room temperature and placed into an Instron tensile tester with an unsealed portion of the tray secured to the bottom jaw and an unsealed portion of the lidding film secured to the top jaw. Each laminated specimen was pulled apart at a 180° angle with at a speed of 12 in/min while the average force to separate the specimen was measured. The seal strength of each laminated specimen was measured at room temperature (23° C.) and in a heated chamber at 93° C. (200° F.). The results are reported in TABLE 1 below.

### Burst Strengths

The burst strengths for the different heat sealing layers of Examples 1-8 and Comparative Example 1 were determined by filling each tray (maximum volume is 600 mL) with approximately 100 mL of water and sealing a lidding film 50 as described above (see FIG. 4) to the flange of each tray. Each filled and sealed tray was placed inside a microwave oven. An optical probe connected to a MWS microwave work station (FISO Technologies, Inc., Quebec, CA) recorded the maximum pressure (psi) inside the sealed tray to rupture the heat seal. The results are reported in TABLE 1 below

TABLE 1

| | | SEAL | SEAL | |
|---|---|---|---|---|
| | Wt.-% | STRENGTH | STRENGTH | BURST |
| | HDPE/Wt.-% | @ 23° C. | @ 93° C. | STRENGTH |
| SAMPLE | APET | (g/in) | (g/in) | (psi) |
| Example 1 | 50/50^{a} | 3185 | 861 | 0.11 |
| Example 2 | 40/60^{a} | 3078 | 1191 | 1.81 |
| Example 3 | 35/65^{a} | 5059 | 1655 | 3.03 |
| Example 4a | 30/70^{a} | 5365 | 2324 | 2.35 |
| Example 4b | 30/70^{b} | 4890 | 1690 | — |
| Example 5 | 25/75^{a} | 4551 | 1707 | 3.16 |
| Example 6 | 20/80^{a} | No peel^{d} | 3455 | 3.05 |
| Example 7 | 15/85^{a} | No peel^{d} | 3339 | 3.38 |
| Example 8 | 60/40^{a} | 2671 | 879 | — |
| Comparative | (100% APET) | 3169 | No peel^{d} | 3.11 |
| Example 1 | | | | |
| Comparative | 35/65^{c} | No seal | No seal | — |
| Example 1 | | | | |

^{a} = APET is EASTOBOND Copolyester 19412 (Eastman Chemical Company, Inc., Kingsport, TN, USA);
^{b} = APET is Type 7391 (Indorama Ventures Auriga Polymers, Inc., Charlotte, NC, USA);
^{c} = APET is Laser+ ® C 9921 (F65A) (DAK Americas LLC, Chadds Ford, PA, USA);
^{d} = no peel refers to delamination occurring at or above 4000 g/in.

It will be learned from the above results that a preferred embodiment of a heat sealing layer of a tray according to the present invention includes, but is not limited to, a substantially amorphous aromatic polyester having only a terephthalatic acid repeating component and greater than 2 mole % or at least 37 mole % of a diethylene glycol diol repeating component or both a terephthalatic acid repeating component and an isophthalatic acid repeating component combined with between 15% and 80% by weight of a polyester-immiscible contaminant, especially high density polyethylene which provides a manually openable heat-resistant package having a seal strength of between 500 g/in and 3,000 g/in at 93° C. (200° F.).

The above description and examples illustrate certain embodiments of the present invention and are not to be interpreted as limiting. Selection of particular embodiments, combinations thereof, modifications, and adaptations of the various embodiments, conditions and parameters normally encountered in the art will be apparent to those skilled in the art and are deemed to be within the spirit and scope of the present invention.

1. A manually openable heat-resistant package for containing a product comprising:
a thermoformed tray having a product receiving area and a sealing flange, wherein the tray comprises:
a bulk layer;
a heat sealing layer in direct contact with the bulk layer and comprising a blend of substantially amorphous aromatic polyester and a polyester-immiscible contaminant;
a flexible transparent lidding film covering the thermoformed product receiving area comprising a heat sealing layer comprising a substantially amorphous aromatic polyester;
a hermetic seal comprising a perimeter heat seal circumventing the thermoformed tray formed by heat sealing a portion of the heat sealing layer of the lidding film to the sealing flange of the tray; wherein the hermetic seal comprises a seal strength of between 500 g/in and 3000 g/in at 93° C. (200° F.); and
wherein only the heat sealing layer of the tray is readily frangible and renders the heat seal manually peelable.

2. A package according to claim 1, wherein the substantially amorphous aromatic polyester copolymer is selected from the group consisting of polyethylene terephthalate, polytrimethylene terephthalate, polybutylene terephthalate, polyhexamethylene terephthalate; polyethylene-2,6-naphthalate, polytrimethylene-2,6-naphthalate, polybutylene-2,6-naphthalate, polyhexamethylene-2,6-natphthalate, polyethylene isophthalate, polytrimethylene isophthalate, polybutylene isophthalate, polyhexamethylene isophthalate, poly-1,4-cyclohexane-dimethanol terephthalate, and polybutylene adipate terephthalate and derivatives thereof.

3. A package according to claim 1, wherein the heat sealing layer of the tray comprises a substantially amorphous aromatic polyester comprising a copolymer comprising a terephthalatic acid repeating component and a diethylene glycol diol repeating component.

4. A package according to claim 3, wherein the diethylene glycol dial repeating component which is present in an amount of greater than 2 mole % of the total copolymer composition.

5. A package according to claim 3, wherein the diethylene glycol dial repeating component is present in an amount of at least 37 mole % of the total copolymer composition.

6. A package according to claim 1, wherein the heat sealing layer of the tray comprises a substantially amorphous aromatic polyester comprising a terephthalatic acid repeating component and an isophthalatic acid repeating component.

7. A package according to claim 1, wherein the bulk layer of the tray comprises a polyethylene terephthalate.

8. A package according to claim 7, wherein the polyethylene terephthalate is crystalline polyethylene terephthalate.

9. A package according to claim 1, wherein the polyester-immiscible contaminant is a polyolefin.

10. A package according to claim 9, wherein the polyolefin is selected from the group consisting of polyethylene, polypropylene, polybutene and blends thereof.

11. A package according to claim 10, wherein the polyethylene is a high density polyethylene.

12. A package according to claim 10, wherein the polyolefin is polypropylene.

13. A package according to claim 1, wherein the heat sealing layer of the tray comprises between 40% and 85% by weight of polyethylene terephthalate or polyethylene terephthalate/isophthalate copolymer relative to the total weight of the heat sealing layer.

14. A package according to claim 1, wherein the heat sealing layer of the tray comprises between 15% and 80% by weight of a polyester-immiscible contaminant relative to the total weight of the heat sealing layer.

15. A package according to claim 1, wherein the hermetic seal has a seal strength of between 1000 g/in and 3,000 g/in at 93° C. (200° F.).

16. A package according to claim 1, wherein the hermetic seal has a peel strength of between 2000 g/in and 3,000 g/in at 93° C. (200° F.).

17. A package according to claim 1, wherein the hermetic seal remains sealed while subjected to a temperature of 100° C. for between 1-10 minutes and under an internal pressure of between 3-4 psi.

18. A package according to claim 1, wherein the flexible lidding film has a haze value of 10% or less.

19. A package according to claim 1, wherein the package comprises an integrally formed tamper-evident feature.

20. A package according to claim 1 wherein the tamper-evident feature comprises visible whitened area of the lidding film produced when the hermetic seal has been breached.

21.-23. (canceled)
